(19) United States
(12) Patent Application Publication
(10) Pub. No.: US 2026/0298624 A1
(43) Pub. Date: Oct. 1, 2026

(54) CONDUIT ALIGNMENT TOOLS AND SYSTEMS

(71) Applicant: Benjamin Sproull, Plainfield, IN (US)

(72) Inventor: Benjamin Sproull, Plainfield, IN (US)

(21) Appl. No.: 19/634,917

(22) Filed: Mar. 31, 2026

Related U.S. Application Data
(60) Provisional application No. 63/780,652, filed on Mar. 31, 2025.

(51) Int. Cl. G01B 11/27

(52) U.S. Cl. CPC G01B 11/27

(57) ABSTRACT

Conduit alignment tools and systems. The conduit alignment tool includes an insert body configured to be inserted snugly into a conduit (for example, a pipe), a stop member extending radially outwardly from the cylindrical insert body for engaging an end of the conduit, and a laser configured to project a laser beam aligned with the axis. The conduit alignment tool system may include the alignment tool along with a set of one or more nesting adapter inserts for adjusting the tool to snugly fit within conduits of different sizes.

### CROSS-REFERENCE TO RELATED APPLICATIONS

This application claims priority to provisional U.S. patent application Ser. No. 63/780,652 filed Mar. 31, 2025, the contents of which are incorporated herein by reference.

### BACKGROUND OF THE INVENTION

The invention relates generally to construction tools, and more particularly to conduit alignment tools and components, devices, and systems associated therewith.

When installing pipe systems and other conduits in an existing building or a building under construction (new construction), it is often necessary to identify where a pipe will extend into a wall, floor, ceiling, roof, or other barrier (referred to herein as barrier(s)) before the pipe is installed all the way to such barriers. This may be necessary, for example, to locate and drill a hole through a barrier through which the pipe is supposed to extend. Currently, to accomplish this, tradespeople typically need to take measurements and/or calculate the projected location of the pipe from plan dimensions. However, this can be time consuming and/or lead to inaccuracies for many different reasons.

It would be desirable to have an improved system for identifying where a conduit (including a pipe) will intersect a barrier for the purpose of facilitating the installation of conduits in existing buildings or buildings under construction.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, conduit alignment tools and adjustable conduit alignment tool systems.

According to a nonlimiting aspect, a conduit alignment tool includes an insert body having a tubular shape and an axis extending from a first end configured to be inserted snugly into a conduit to a second end, a stop member extending radially outwardly from the cylindrical insert body for engaging an end of the conduit when the first end is inserted into the conduit, and a laser configured to project a laser beam away from the second end aligned with the axis.

According to another nonlimiting aspect, an adjustable conduit alignment tool system includes a conduit alignment tool as described above and an adapter insert. The adapter insert includes a hollow cylindrical member having a first axial end sized to receive the insert body of the conduit alignment tool therein and a stop member disposed at the first radial end. The conduit alignment tool nests within the adapter insert, and the stop member of the adapter insert engages the stop member of the conduit alignment tool.

Technical aspects of conduit alignment tools as described above preferably include the ability to facilitate the installation of conduits in existing buildings or buildings under construction, thus offering the ability to save time and/or improve accuracy during building renovation and construction.

These and other aspects, arrangements, features, and/or technical effects will become apparent upon detailed inspection of the figures and the following description.

### BRIEF DESCRIPTION OF THE DRAWINGS

FIG. 1 is a diagrammatic depiction of one possible use of a conduit alignment tool according to an embodiment of the invention.

FIG. 2 is a perspective view of the conduit alignment tool.

FIG. 3 is a perspective view of the conduit alignment tool with some outer portions removed to expose internal components.

FIG. 4 is a perspective view of an adjustable conduit alignment tool system including the conduit alignment tool nestable within a set of nesting adapter inserts for adjusting to conduits of different sizes.

FIG. 5 is a bottom view of one of the adapter inserts.

FIG. 6 is a diagrammatic cross-sectional view of the conduit alignment tool nested within the set of nesting adapter inserts.

FIG. 7 is a perspective view of a conduit alignment tool according to another nonlimiting embodiment of the invention.

FIG. 8 is a perspective view of the conduit alignment tool of FIG. 7 in a partially disassembled condition to show interior components.

FIG. 9 is an axial cross-sectional view of the conduit alignment tool of FIG. 7 showing the interior components from another perspective.

FIG. 10 is a perspective view of an adjustable conduit alignment tool system including the conduit alignment tool of FIG. 7 nestable within a set of nesting adapter inserts for adjusting to conduits of different sizes according to another embodiment of the invention.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of what is depicted in the drawings, including the embodiment(s) to which the drawings relate. The following detailed description also identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to recite what are believed to be some, but not necessarily all aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

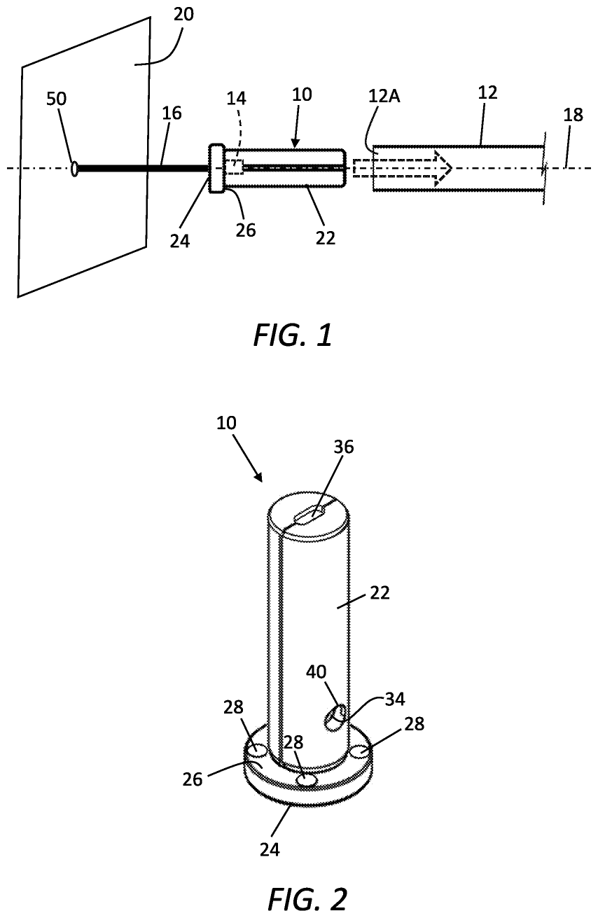

As seen in FIGS. 1 and 2, a conduit alignment tool 10 can be inserted into an open end of a tubular-shaped conduit, as a nonlimiting example, a cylindrical hollow pipe 12 represented in FIG. 1. The conduit alignment tool 10 includes a laser beam generator (hereinafter, laser) 14 that is configured to project a laser beam 16 aligned with the centerline 18 of the pipe 12 onto a barrier, represented in FIG. 1 as a wall 20, so that tradespeople do not need to take measurements to drill a hole for a wall penetration of the pipe 12 when extended thereto. It is understood that the term “pipe” as used as a matter of convenience, and that the following description can be applied to essentially any elongate cylindrical hollow conduit, such as a tube or other similar structures.

The conduit alignment tool 10 has a tubular-shaped insert body 22 sized and shaped to fit snuggly into the pipe 12. In this example, the insert body 22 is formed by an elongate outer cylindrical shell with an outside diameter that is sized to fit snuggly into the pipe 12, which has a known inside diameter; however, the insert body 22 does not necessarily need to be perfectly circular cylindrical as long as the body can fit snugly into the end of the pipe 12. For example, the insert body 22 may have an outside diameter slightly smaller than 22 mm so that the insert body 22 can be inserted into an opening 12A of the pipe 12 having a 22 mm inside diameter and maintain the axis of the insert body 22 aligned with the axis 18 of the pipe 12. An end cap 24 disposed at one axial end of the insert body 22 covers or closes the end of the insert body 22. In this embodiment, the end cap 24 has the general form of a circular disc.

A stop member 26 extends radially outwardly from the insert body 22 to define a shoulder that is sized and shaped to engage the wall or rim surrounding the opening 12A of the pipe 12 and prevent the alignment tool 10 from sliding all the way into the pipe 12 when the insert body 22 is inserted into the opening 12A. In this embodiment, the stop member 26 is in the form of a radial flange that is defined by the end cap 24 and extends radially beyond the outside diameter of the insert body 22 and at least partially and preferably entirely around the entire circumference of the insert body 22. As such, the stop member 26 is essentially the outer periphery of the end cap 24 having an outside diameter that is larger than the outside diameter of the insert body 22. It is also within the scope of the invention that the stop member 26 may be formed to have other shapes and/or configurations. The stop member 26 is sized to engage the end of the pipe 12 when the insert body 22 is inserted into the opening 12A of the pipe 12. In this way, the stop member 26 acts as a feature capable of preventing the conduit alignment tool 10 from sliding all the way into the pipe 12.

As depicted in FIG. 2, one or more magnets 28 are disposed in the stop member 26 adjacent the perimeter thereof. In this example, four magnets 28 are carried in the stop member 26 spaced equidistantly near the outside diameter of the insert body 22. Each magnet 28 may extend completely through the axial thickness of the stop member 26 to be exposed on each opposite axial side of the stop member 26. The magnet(s) 28 releasably/magnetically secure the conduit alignment tool 10 to the end of the pipe 12 when the insert body 22 is inserted into its opening 12A.

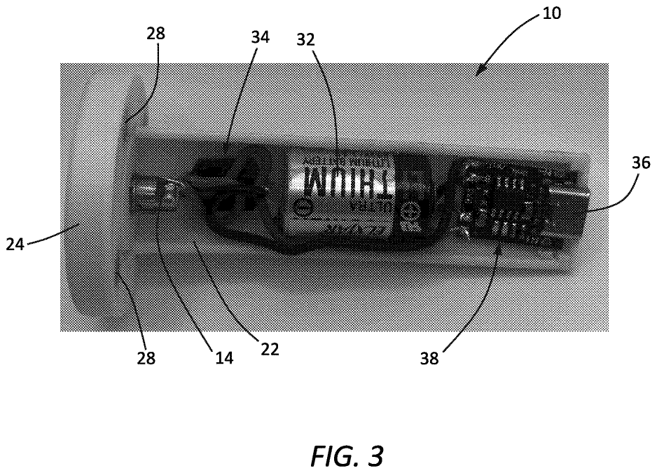

As best seen in FIG. 3, the laser 14 and a battery 32 are disposed inside the outer cylindrical shell of the insert body 22. FIG. 2 depicts an on/off switch 34 as accessible from the exterior of the insert body 22 through an aperture 40 in the body 22 to enable a user to turn the laser 14 on and offer from the exterior of the tool 10.

The laser 14 may be recessed inward from the outer surface of the axial end wall of the end cap 24 so that the laser 14 is protected from accidental impacts during use, for example, by being dropped. For example, the laser 14 may be disposed inside the insert body 22 and the laser beam 16 may shine through another aperture in the end cap 24. Preferably, the laser beam 16 and the aperture are axially aligned with the longitudinal axis of the insert body 22 so that the laser beam 16 is coaxially aligned with the axis 18 of the pipe 12 when the alignment tool 10 is operatively inserted into the opening 12A. The laser 14 in this example may be a laser diode that generates the laser beam 16 of the pipe 12. However other types of lasers and systems for generating the laser beam 16 or any similar beam of parallel light rays may be used. As used herein the terms “laser beam” and “laser” include any such beam of parallel light rays and a light source configured to generate such a beam.

The battery 32 may be any suitable electrical storage device, such as an electrochemical cell. In this example, the battery 32 is preferably a rechargeable battery that includes a rechargeable electrochemical cell. A charging port 36 is preferably provided for charging the rechargeable battery 32. In this example, the charging port 36 includes a USB-C port operatively coupled to the battery 32 with a voltage transformer 38 provided on an integrated circuit, though other charging means and port configurations could be used.

The switch 34 is positioned in the aperture 40 of the insert body 22 to be accessible to a user through the sidewall of the body 22. The switch 34 is preferably recessed within the aperture 40 below the outer surface of the sidewall to prevent the switch 34 from interfering with insertion of the insert body 22 into the pipe 12 or, as discussed hereinafter, an adapter insert 42. In this example, the switch 34 is a push-type button on/off switch, though other types of on/off switches may be used. The switch 34 is operatively interposed in the circuit between the battery 32 and the laser 14 to selectively close and/or open the circuit for turning the laser 14 on and/or off.

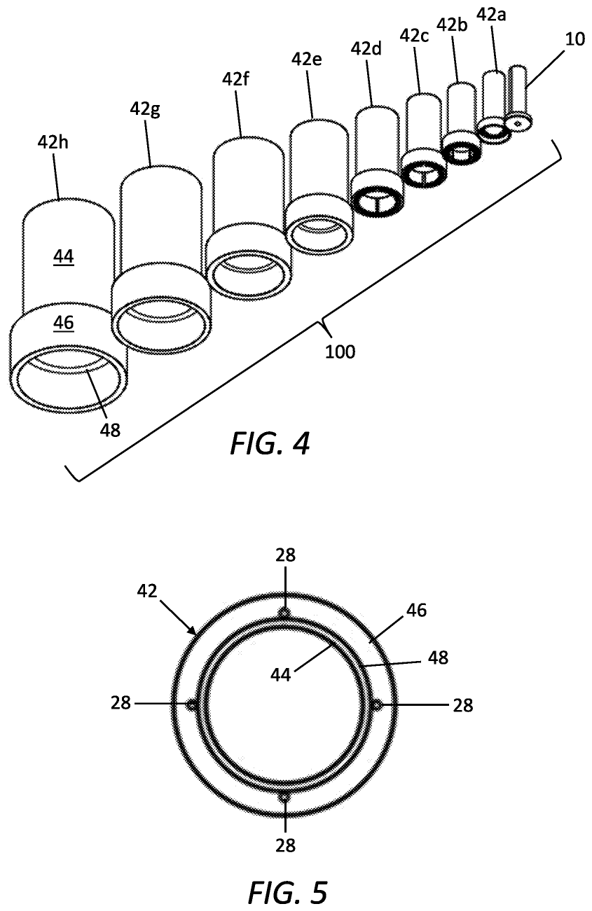

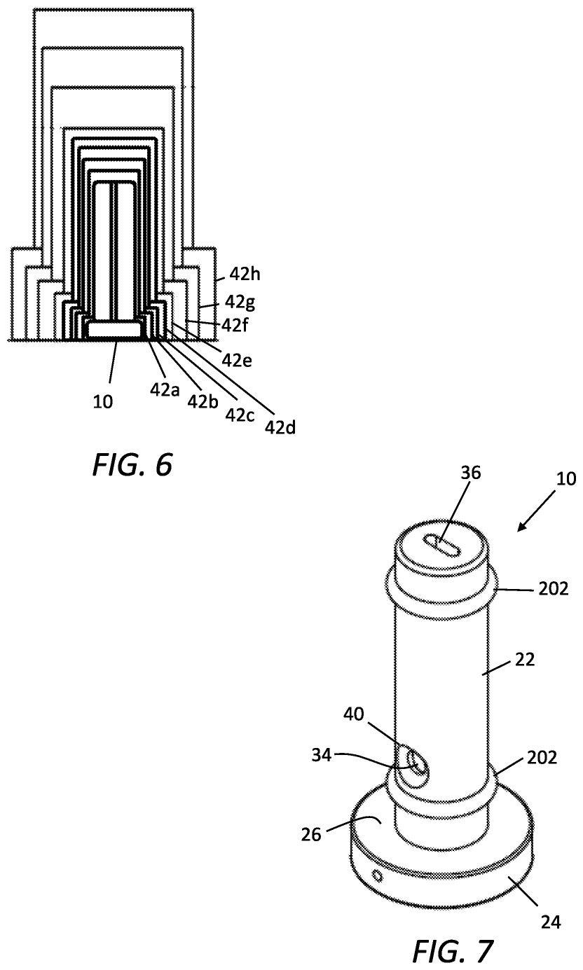

Because there are many various standardized sizes of conduits used in the construction industry, the conduit alignment tool 10 is preferably usable in an adjustable conduit alignment tool system 100 that includes one or more sets of adapter inserts 42 configured to allow the tool 10 to be snugly operatively inserted into conduits of different sizes. In this example, a set of eight adapter inserts 42, individually identified as adapter inserts 42a through 42h, are depicted though the use of fewer and greater numbers of adapter inserts 42 are foreseeable. The adapter inserts 42a-42h have progressively larger outside diameters and inside diameters such that each adapter insert 42 nests sequentially from the smallest adapter insert 42a into the largest adapter insert 42h while also holding the conduit alignment tool 10. As best seen in FIGS. 4-6, each adapter insert 42a-42h includes an elongate hollow cylindrical insert body 44 and a stop member 46 disposed at one end of the insert body 44. The insert body 44 has an inside diameter sized to snugly receive the outside diameter of the insert body 44 of the next smaller adapter insert 42 or the conduit alignment tool 10, as the case may be. For example, as illustrated diagrammatically in FIG. 5, the insert body 22 of the tool 10 fits snugly into the insert body 44 of the first larger adapter insert 42a, the insert body 44 of the adapter insert 42a, fits snugly into the next larger adapter insert 42b, and so on up to the largest adapter insert 42h. An inner circumferential shoulder 48 extends circumferentially around the inner wall of the adapter insert 42 at the junction between the stop member 46 and the insert body 44 such that the stop member 46 of the next smaller sized adapter insert 42 (or the stop member 26 of the tool 10) abuts against the inner circumferential shoulder 48 when the smaller adapter insert 42 is fully inserted into the central bore of the next larger adapter insert 42.

Similar to the conduit alignment tool 10, each adapter insert 42 includes one or more magnets 28 associated with its stop member 46 for magnetically coupling each adapter insert 42 to the next larger adapter insert 42 into which it is inserted. In this example, each adapter insert 42a-42h includes four magnets 28 disposed equidistant from each other around the circumference of the respective stop member 46 thereof, though more or fewer magnets could be used. The magnets 28 may be exposed or located immediately adjacent to opposite axial sides of the stop member 46. In some embodiments, separate magnets 28 are recessed into receiver recesses in each of the two axial facing sides of the stop member 46. In other embodiments, each magnet 28 may extend axially all the way through the stop member 46 from one axial side to the opposite axial side. The magnets 28 are configured such that throughout the entire set of the adapter inserts 42 the same pole (i.e., either N or S) of the magnets 28 is disposed facing the end of the insert body 44 and the stop member 46 and the opposite pole of the magnets 28 is disposed facing the opposite end of the stop member 46 so that the magnets 28 of one insert 42 will be attracted to the magnets 28 of the insert 42 into which is being inserted (rather than being repulsed). The magnets 28 allow the alignment tool 10 as well as the adapter inserts 42 to be used either horizontally or vertically by keeping them in place while pointing downwardly, for example.

With reference to FIG. 1, to use the conduit alignment tool 10 and the system 100 a user turns on the laser 14 by activating the switch 34, then inserts the insert body 22 into the opening 12A of the pipe 12 until the stop member 26 abuts against the end wall of the pipe 12. If the inside diameter of the pipe 12 is larger than the outside diameter of the insert body 22, additional adapter inserts 42 of successively larger diameters (e.g., 42a, 42b, 42c, etc.) are mounted onto the alignment tool 10 until the outermost adapter insert 42 fits snugly into the opening 12A of the pipe 12. The laser beam 16 is then aligned axially with the axis 18 of the pipe 12 and shines a target spot 50 on the wall 20 (or any other surface in line with the pipe's axis 18), thus identifying where the pipe 12, when extended to the wall 20, will be. Then, for example, a hole may be formed in the wall 20 exactly where the pipe 12 will be based on the target spot 50.

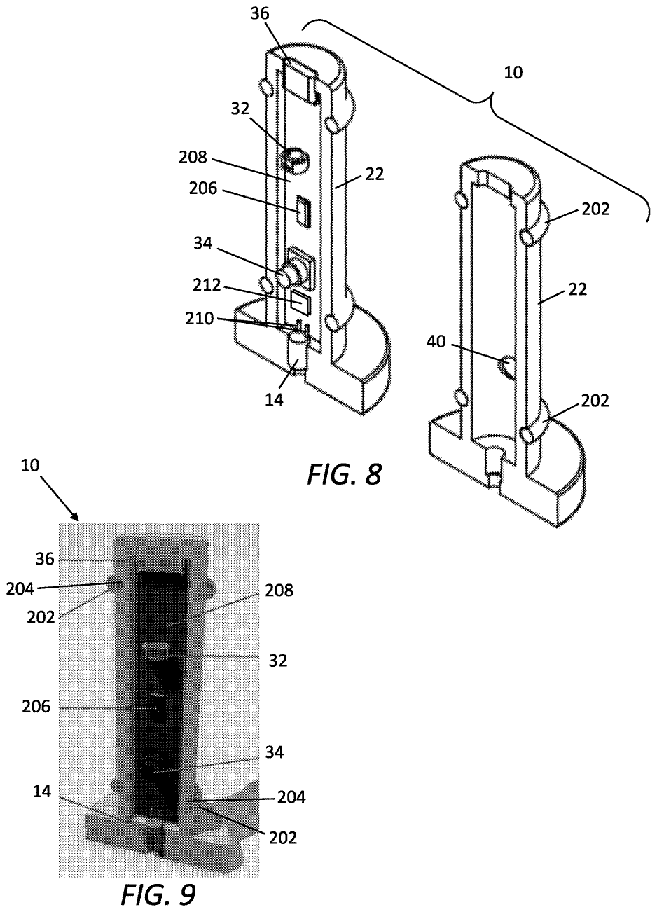

FIGS. 7 through 10 represent a second nonlimiting embodiment of the conduit alignment tool 10 that includes many of the same or substantially similar features as already described relative to the embodiment of FIGS. 1 through 6, but with some modifications and additions that are described in detail hereinafter. In view of similarities between the embodiments of FIGS. 1 through 6 and FIGS. 7 through 10, the following discussion of the second embodiment of FIGS. 7 through 10 will focus primarily on aspects of this embodiment that differ from the first embodiment of FIGS. 1 through 6 in some notable or significant manner. Other aspects of the second embodiment not discussed in any detail can be, in terms of structure, function, materials, etc., essentially as was described for the first embodiment.

The conduit alignment tool 10 of FIGS. 7 through 10 includes the laser 14 disposed in one end of cylindrical insert body 22 and the end cap 24 disposed at the same end of the body 22 as the laser 14, all configured so that the conduit alignment tool 10 can be inserted into the open end of a tubular-shaped pipe (conduit) 12 similarly as represented in FIG. 1. In this embodiment, instead of using magnets 28, the alignment tool 10 includes at least one engagement member 202 that defines a protrusion projecting radially outward from at least a portion of the outer surface of the insert body 22 for frictionally engaging against the inner surface(s) of the pipe 12 to create a releasable friction fit coupling for the tool 10 within the opening 12A of the pipe 12. In this example, the engagement member 202 is an elastomeric O-ring that encircles the outer circumference of the insert body 22 such that the protrusion defined thereby projects radially outward from the outer surface of the insert body 22 along the entire circumference of the insert body 22. However, the engagement member 202 need not completely encircle the entire radial perimeter of the insert body 22. For example, in other embodiments, the engagement member 202 may only partly encircle the insert body 22 and/or have a plurality of smaller, separated, spaced-apart portions that are disposed around the outer perimeter of the insert body 22, such as a plurality of distinct radial knobs or other shaped projections. In this example, the alignment tool 10 has two O-ring shaped engagement members 202 disposed near opposite ends of the insert body 22: a first engagement member 202 being between the end cap 26 and the switch aperture 40, and a second engagement member 202 being near the opposite end where the charging port 36 is located. The engagement members 202 may slide or roll onto the outer surface of the insert body 22. A circumferential groove 204 is shown as recessed into the outer surface of the insert body 22 at the location of each of the engagement members 202 into which the engagement members 202 can be seated to help retain the engagement members 202 in preselected locations along the length of the insert body 22. In other embodiments, more or fewer engagement members 202 could be disposed along the length of the insert body 22. The engagement member(s) 202 are preferably formed of a rubber or other elastomeric material suitable for creating a resilient friction fit with the interior wall of the pipe 12. In other embodiments, the engagement members 202 may be made of different materials, such as cloth, felt, etc., that can provide a slightly soft and resilient engagement against the interior surface of the pipe 12. By using the engagement member(s) 202, the magnets 28 of the alignment tool 10 of FIGS. 1 through 6 may be omitted entirely, although in some embodiments, the alignment tools 10 of FIGS. 7-10 could include both magnets 28 and the engagement member(s) 202. The engagement members 202 accommodate size variances and tolerances of various conduits and different conduit materials while also providing enough friction to sufficiently hold the alignment tool 10 securely in place during use, including during use if the pipe (conduit) 12 is oriented so that its axis 18 is vertical or nearly so.

As illustrated in FIGS. 7 through 10, the electrical components (e.g., laser 14, battery 32, on/off push-button switch 34, charging port 36, and voltage transformer 38) may be integrated onto a single circuit board 208 to improve alignment, reliability, and repeatability while reducing internal complexity. An automatic shutoff timer 206 that automatically turns the laser 14 off after a predetermined amount of time may also be provided. The automatic shutoff timer 206 is preferably disposed inside the insert body 22 along with the remaining electrical components.

One or more set screws 210 may be provided to allow the position of the laser module 14 to be adjusted. For example, the set screws 210 can be used to adjust the alignment of the laser beam 16 emitted from the laser 14 concentrically to be coaxial with the longitudinal axis of the insert body 22.

FIGS. 7 through 10 depict the alignment tool 10 as further including a laser distance measurement module 212 adapted to provide distance measurements from the laser beam 16. For example, the laser distance measurement module 212 may measure and provide a readout to the user of a distance from the alignment tool 10 to a target wall or other target surface. The laser distance measurement module 212 may be incorporated with the circuit board 208, similar to the other electrical components. The laser distance measurement module 212 may be any available laser measurement circuitry and hardware suitable for obtaining such distance measurements.

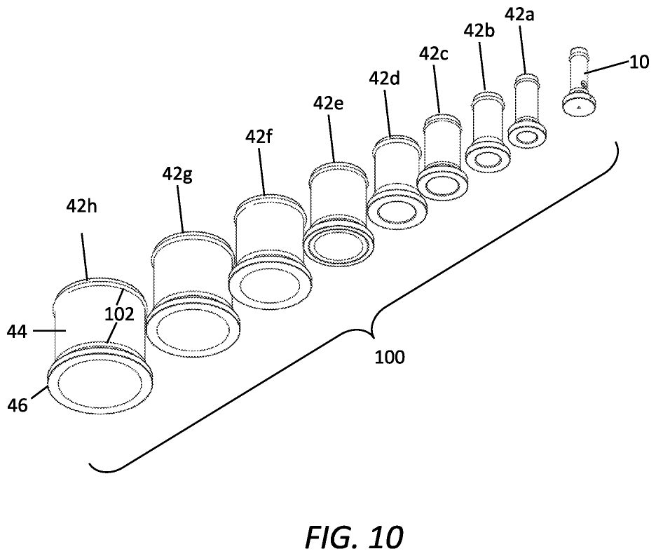

As illustrated in FIG. 10, the alignment tool 10 of FIGS. 7 through 9 can be provided as part of a conduit alignment tool system 100 that includes one or more sets of adapter inserts 42 configured to nest together in stepwise increasingly larger widths to allow the tool 10 to be snugly operatively inserted into conduits of different sizes. The system 100 of FIG. 10 is generally similar to the system 100 of FIG. 4, however in FIG. 10 the adapter inserts 42 are represented as further including appropriately sized engagement members 202 on the exterior surfaces thereof to hold the adapter inserts 42 together when nested within each other, rather than the magnets 28 used in the system 100 of FIG. 4.

The conduit alignment tools 10 and the adapter inserts 42 represented in the drawings may be made of any suitable materials. In some nonlimiting embodiments, the alignment tools 10 and adapter inserts 42 are made of one or more plastics, such as polylactic acid (PLA), acrylonitrile butadiene styrene (ABS), other suitable polymeric materials, such as polyvinyl chloride (PVC), and/or one or more metals, such as aluminum, iron, steel, or brass.

Some advantages of the conduit alignment tools 10 and systems 100 as described above include time savings and the ability to reduce the risk of mathematical or measurement errors when calculating where a conduit (e.g., pipe) will penetrate an adjacent wall. Alternative uses other than concentric conduit projection may include measuring offsets for obstructions in the line of a conduit or conduit run, conduit run layout, and giving a constant measuring point to keep spacing on a rack of a conduit. The conduit alignment tools 10 and systems 100 may be adapted and/or directly used in other use cases. For example, the conduit alignment tools 10 and systems 100 may be used to fit plumbing, process piping, and generally any other types of pipes that an installer, such as a plumber, pipe fitter, electrician, carpenter, or any other person may encounter.

The conduit alignment tools 10 and systems 100 preferably can save time and/or improve accuracy during building renovation and construction. Because walls, floors, or roofs of new and existing buildings are rarely at exactly the planned pitches and measurements, the alignment tools 10 and systems 100 can help eliminate inaccuracies when installing conduit into or through walls, floors, and/or roofs.

As previously noted above, though the foregoing detailed description describes certain aspects of one or more particular embodiments of the invention, alternatives could be adopted by one skilled in the art. For example, the conduit alignment tool system 100, including the conduit alignment tool 10, the adapter inserts 42, and their components, could differ in appearance and construction from the embodiments described herein and shown in the drawings, functions of certain components of the conduit alignment tool system 100 could be performed by components of different construction but capable of a similar (though not necessarily equivalent) function, and various materials could be used in the fabrication of the conduit alignment tool system 100 and/or its components. As such, and again as was previously noted, it should be understood that the invention is not necessarily limited to any particular embodiment described herein or illustrated in the drawings.

1. A conduit alignment tool comprising:
an insert body having a tubular shape and an axis extending from a first end configured to be inserted snugly into a conduit to a second end;
a stop member extending radially outwardly from the cylindrical insert body for engaging an end of the conduit when the first end is inserted into the conduit; and
a laser configured to project a laser beam away from the second end aligned with the axis.

2. The conduit alignment tool of claim 1, wherein the stop member comprises a radial flange.

3. The conduit alignment tool of claim 2, wherein the stop member extends completely around a circumference of the insert body.

4. The conduit alignment tool of claim 1, further comprising a magnet carried by the stop member and configured to magnetically secure the conduit alignment tool to the end of the conduit when the first end is inserted into the conduit.

5. The conduit alignment tool of claim 4, wherein the magnet has a first magnetic pole on a first axial side of the stop surface and a second magnetic pole on a second axial side of the stop surface.

6. The conduit alignment tool of claim 5, wherein at least one of the first magnetic pole and the second magnetic pole is exposed at the respective first axial side of the stop member or second axial side of the stop member.

7. The conduit alignment tool of claim 1, further comprising an engagement member projecting from an exterior surface of the insert body for forming a friction fit with an interior wall of the conduit.

8. The conduit alignment tool of claim 7, wherein the engagement member comprises an elastomeric protrusion.

9. The conduit alignment tool of claim 7, wherein the engagement member comprises an O-ring.

10. The conduit alignment tool of claim 1, further comprising an on/off switch carried within the cylindrical insert body.

11. The conduit alignment tool of claim 10, wherein the on/off switch is exposed to an exterior of the cylindrical insert body and is recessed beneath an exterior surface of the cylindrical insert body.

12. The conduit alignment tool of claim 1, wherein the laser is disposed inside the insert body and recessed below an exterior surface of an end cap covering the second end.

13. The conduit alignment tool of claim 1, further comprising a battery carried within the insert body and operatively coupled to the laser to power the laser.

14. The conduit alignment tool of claim 13, wherein the battery comprises a rechargeable electrochemical cell, and further comprising a charging port for charging the rechargeable electrochemical cell.

15. The conduit alignment tool of claim 1, further comprising an automatic shutoff timer configured to automatically turn the laser off after a predetermined amount of time.

16. The conduit alignment tool of claim 1, further comprising a set screw for adjusting the position of the laser.

17. The conduit alignment tool of claim 1, further comprising a laser distance measurement module for measuring a distance from the alignment tool to a target surface.

18. An adjustable conduit alignment tool system comprising:
the conduit alignment tool of claim 1; and
an adapter insert comprising:
a hollow cylindrical member having a first axial end sized to receive the insert body of the conduit alignment tool therein; and
a second stop member disposed at the first radial end;
wherein the conduit alignment tool nests within the adapter insert, and the stop member of the adapter insert engages the stop member of the conduit alignment tool.

19. The adjustable conduit alignment tool system of claim 18, further comprising:
a magnet carried by the first said stop member; and
a second magnet carried by the second stop member,
wherein the first and second magnets magnetically secure the conduit alignment tool nested within the adapter insert.

20. The adjustable conduit alignment tool system of claim 18, further comprising:
a first elastomeric engagement member disposed on an outer surface of the insert body; and
a second elastomeric engagement member disposed on an outer surface of the hollow cylindrical member,
wherein the first elastomeric engagement member releasably retains the conduit alignment tool nested within the hollow cylindrical member, and the second elastomeric engagement member is for releasably retaining the adapter insert inside the conduit.

21. The adjustable conduit alignment tool system of claim 18, wherein the adapter insert is a first adapter insert and the adjustable conduit alignment tool further comprises a second adapter insert, wherein the first adapter insert is configured to nest inside the second adapter insert.
